(19) United States
(12) Patent Application Publication
(10) Pub. No.: US 2023/0281513 A1
(43) Pub. Date: Sep. 7, 2023

(54) DATA MODEL TRAINING METHOD AND APPARATUS

(71) Applicant: HUAWEI TECHNOLOGIES CO., LTD., Shenzhen (CN)

(72) Inventors: Jian WANG, Hangzhou (CN); Tianhang YU, Hangzhou (CN); Chen XU, Hangzhou (CN); Rong LI, Hangzhou (CN); Jun WANG, Hangzhou (CN)

(21) Appl. No.: 18/313,590

(22) Filed: May 8, 2023

Related U.S. Application Data
(63) Continuation of application No. PCT/CN2021/131907, filed on Nov. 19, 2021.

(30) Foreign Application Priority Data
Nov. 26, 2020 (CN) 202011349018.4

(51) Int. Cl. G06N 20/00

(52) U.S. Cl. CPC G06N 20/00

(57) ABSTRACT

A data model training method and apparatus are provided. The method includes receiving data subsets from a plurality of subnodes and performing data convergence based on the plurality of data subsets to obtain a first data set. A first data model and at least one of the first data set or a subset of the first data set are sent to a first subnode, where an artificial intelligence (AI) algorithm is configured for the first subnode. A second data model is received from the first subnode, where the second data model is obtained by training the first data model based on the first data set or the subset of the first data set. The first data model is updated based on the second data model to obtain a target data model, the target data model is sent to the plurality of subnodes.

### CROSS-REFERENCE TO RELATED APPLICATIONS

This application is a continuation of International Application No. PCT/CN2021/131907, filed on Nov. 19, 2021, which claims priority to Chinese Patent Application No. 202011349018.4, filed on Nov. 26, 2020. The disclosures of the aforementioned applications are hereby incorporated by reference in their entireties.

### TECHNICAL FIELD

This application relates to the field of computer technologies and the field of machine learning technologies, and in particular, to a data model training method and apparatus.

### BACKGROUND

With the increasing popularity of big data applications, each user device generates a large quantity of original data in various forms. In conventional central machine learning, device data on each edge device may be collected and uploaded to a central cloud server. The cloud server performs training iteration on a data model based on the device data by using an artificial intelligence (AI) algorithm in a centralized manner, to obtain a data model, so that a service such as inference computing or decision making can be intelligently provided for a user based on the data model.

A conventional central machine learning algorithm requires a large quantity of edge devices to transmit all local data to a server in a computing center, and then perform model training and learning by using a collected data set. However, with diversification of the device data and complexity of a learning scenario and a learning task, central transmission of a large quantity of data causes a long delay and a large communication loss. In addition, the central machine learning has a high requirement for a machine learning capability of the cloud server, and real-time performance and processing efficiency of the cloud server need to be improved.

In addition, in an existing federated learning (FL) technology, each edge device and a central server collaborate to efficiently complete a learning task of a data model. Specifically, in an FL framework, distributed nodes separately collect and store local device data, and perform training based on the local device data to obtain a local data model of the distributed node. A central node collects data models obtained through training by the plurality of distributed nodes, performs convergence processing on the plurality of data models to obtain a global data model, delivers the global data model to the plurality of distributed nodes, and continuously performs model training iteration until the data model converges. The central node in the FL technology does not have a data set, and is only responsible for performing convergence processing on training results of the distributed nodes to obtain a global model, and delivering the global model to the distributed nodes.

Therefore, in the foregoing FL technology, when the local device data of each distributed node meets an independent and identically distributed characteristic, for example, when dependency and association between the device data are low, performance of the global data model obtained through convergence processing by the central node based on the plurality of local data models is good; when the local device data of each distributed node does not meet the independent and identically distributed characteristic, the performance of the global data model obtained through convergence processing by the central node is poor.

### SUMMARY

This application provides a data model training method and apparatus, to improve computing performance of a data model in distributed machine learning.

To achieve the foregoing objective, this application uses the following technical solutions.

According to a first aspect, a data model training method is provided. The method is applied to a central node included in a machine learning system. The method includes: receiving data subsets from a plurality of subnodes, and performing data convergence based on the plurality of data subsets to obtain a first data set; sending a first data model and the first data set or a subset of the first data set to a first subnode, where an artificial intelligence AI algorithm is configured for the first subnode; receiving a second data model from the first subnode, where the second data model is obtained by training the first data model based on the first data set or the subset of the first data set and local data of the first subnode; and updating the first data model based on the second data model to obtain a target data model, and sending the target data model to the plurality of subnodes, where the plurality of subnodes include the first subnode.

In the foregoing technical solution, a central node collects device data reported by the plurality of subnodes, so that the central node and at least one subnode perform training in collaboration based on collected global device data, to avoid a problem in a conventional technology that data model performance is poor because a distributed node performs training based on a local data set. This improves performance of a machine learning algorithm and user experience.

In a possible design, the sending a first data model to a first subnode specifically includes: sending, to the first subnode, at least one of parameter information and model structure information of the local first data model of the central node.

In the foregoing possible design manner, the central node may deliver a global data model to the first subnode by delivering the parameter information or the model structure information of the data model, to reduce resource occupation of data transmission and improve communication efficiency.

In a possible design, the receiving a second data model from the first subnode specifically includes: receiving parameter information or gradient information of the second data model from the first subnode.

In the foregoing possible design manner, the central node receives the second data model generated through training by the first subnode, and may receive the parameter information or the gradient information of the second data model, so that the central node may perform convergence and update the global data model based on the received parameter information or gradient information, and continue to perform a next round of training to obtain an optimized data model.

In a possible design, the updating the first data model based on the second data model to obtain a target data model specifically includes: performing model convergence on the second data model and the first data model to obtain the target data model; or converging the second data model with the first data model to obtain a third data model, and training the third data model based on the first data set or the subset of the first data set to obtain the target data model.

In the foregoing possible design manner, the central node may obtain the target data model by updating the local global data model based on a received data model obtained through training by the at least one subnode or by continuing to train a global data set based on a data model obtained through training by the at least one subnode, to improve training performance.

In a possible design, the sending a first data model and the first data set or a subset of the first data set to a first subnode specifically includes: preferentially sending the first data model based on a capacity of a communication link for sending data; and if a remaining capacity of the communication link is insufficient to meet a data volume of the first data set, randomly and evenly sampling data in the first data set based on the remaining capacity of the communication link to obtain the subset of the first data set, and sending the subset of the first data set to the first subnode.

In the foregoing possible design manner, when sending the first data model and the global data set to the subnode, the central node may preferentially send the global data model in consideration of the capacity of the communication link, to ensure that training is performed and a better data model is obtained. Further, random sampling is performed on the global data set based on the remaining capacity of the communication link, and training data is sent, to ensure that a data distribution characteristic of a sub-data set trained by the subnode is basically the same as that of the global data set, to overcome a problem in the conventional technology that training performance is poor in non-independent and identically distribution, and improve data model performance.

In a possible design, if the data subset of the subnode includes a status parameter and a benefit parameter of the subnode, the receiving data subsets from a plurality of subnodes specifically includes: receiving a status parameter from a second subnode; inputting the status parameter into the local first data model of the central node, to obtain an output parameter corresponding to the status parameter; sending the output parameter to the second subnode, so that the second subnode performs a corresponding action based on the output parameter; and receiving a benefit parameter from the second subnode, where the benefit parameter indicates a feedback obtained by performing the corresponding action based on the output parameter.

In the foregoing possible design manner, for a reinforcement learning algorithm, the central node may collect the status parameter and the benefit parameter of the subnode that are for data model training. For the second subnode for which no AI algorithm is configured, the second subnode may implement inference computing by using the central node, to obtain the corresponding benefit parameter based on the status parameter of the subnode, to perform training, improve diversity of global data collection, and improve training performance.

According to a second aspect, a data model training processing method is provided. The method is applied to a first subnode included in a machine learning system. An artificial intelligence AI algorithm is configured for the first subnode. The method includes: receiving a first data model and a first data set or a subset of the first data set from a central node, where the first data set is generated by the central node by converging data subsets from a plurality of subnodes; training the first data model based on the first data set or the subset of the first data set and local data, to obtain a second data model; sending the second data model to the central node; and receiving a target data model from the central node, where the target data model is obtained by updating based on the second data model.

In the foregoing technical solution, the first subnode performs training by using a global data set and a global data model that are delivered by the central node, to obtain an update of the data model, and reports the update to the central node. This relieves data computing pressure of the central node. In addition, training is performed based on the global data set of the machine learning system, to avoid a problem in the conventional technology that data model performance is poor because a distributed node performs training based on a local data set. This improves performance of a machine learning algorithm and user experience.

In a possible design, the receiving a first data model from a central node specifically includes: receiving at least one of parameter information and model structure information of the first data model from the central node.

In a possible design, if the first subnode has a data collection capability, the training the first data model based on the first data set or the subset of the first data set, to obtain a second data model specifically includes: converging the first data set or the subset of the first data set with data locally collected by the first subnode, to obtain a second data set; and training the first data model based on the second data set, to obtain the second data model.

In a possible design, the sending the second data model to the central node specifically includes: sending parameter information or gradient information of the second data model to the central node.

According to a third aspect, a data model training method is provided. The method is applied to a central node included in a machine learning system. The method includes: sending a first data model to a first subnode, where an artificial intelligence AI algorithm is configured for the first subnode; receiving a second data model from the first subnode, where the second data model is obtained by training the first data model based on local data of the first subnode; updating the first data model based on the second data model to obtain a third data model; receiving data subsets from a plurality of subnodes, and performing data convergence based on the plurality of data subsets to obtain a first data set; and training the third data model based on the first data set to obtain a target data model, and sending the target data model to the plurality of subnodes, where the plurality of subnodes include the first subnode.

In the foregoing technical solution, the central node performs training in collaboration with at least one distributed node, and the distributed subnode may train, based on local data, a global data model delivered by the central node, and report an obtained local data model to the central node. The central node collects device data reported by the plurality of subnodes, so that the central node performs, based on a global data set, global training on a data model collected by the at least one distributed node. The global data model delivered by the central node is obtained through training based on the global data set, and the distributed node updates the local data model by using the global data model, to avoid a problem in the conventional technology that data model performance is poor because the distributed node performs training based on a local data set. This improves performance of a machine learning algorithm and user experience.

In a possible design, the sending a first data model to a first subnode specifically includes: sending, to the first subnode, at least one of parameter information and model structure information of the local first data model of the central node.

In a possible design, the receiving a second data model from the first subnode specifically includes: receiving parameter information or gradient information of the second data model from the first subnode.

In a possible design, the updating the first data model based on the second data model to obtain a third data model specifically includes: performing model convergence on the second data model and the first data model to obtain the third data model.

In a possible design, if the data subset of the subnode includes a status parameter and a benefit parameter of the subnode, the receiving data subsets from a plurality of subnodes specifically includes: receiving a status parameter from a second subnode; inputting the status parameter into the local first data model of the central node, to obtain an output parameter corresponding to the status parameter; sending the output parameter to the second subnode, so that the second subnode performs a corresponding action based on the output parameter; and receiving a benefit parameter from the second subnode, where the benefit parameter indicates a feedback obtained by performing the corresponding action based on the output parameter.

According to a fourth aspect, a data model training method is provided. The method is applied to a first subnode included in a machine learning system. An artificial intelligence AI algorithm is configured for the first subnode. The method includes: receiving a first data model from a central node; training the first data model based on local data of the first subnode, to obtain a second data model; sending the second data model to the central node; and receiving a target data model from the central node, where the target data model is obtained by updating based on the second data model.

In the foregoing technical solution, at least one distributed subnode may perform training based on a global data model delivered by the central node and in combination with locally collected data, and report an obtained data model to the central node. The central node converges local data models and local data sets that are reported by a plurality of distributed subnodes to obtain the global data model and a global data set, so that training can also be completed collaboratively, to resolve a problem in the conventional technology that performance of training for a non-independent and identically distributed characteristic and improve training performance.

In a possible design, the receiving a first data model from a central node specifically includes: receiving at least one of parameter information and model structure information of the first data model from the central node.

In a possible design, the sending the second data model to the central node specifically includes: sending parameter information or gradient information of the second data model to the central node.

According to a fifth aspect, a data model training apparatus is provided. The apparatus includes: a receiving module, configured to: receive data subsets from a plurality of subnodes, and perform data convergence based on the plurality of data subsets to obtain a first data set; a sending module, configured to send a first data model and the first data set or a subset of the first data set to a first subnode, where an artificial intelligence AI algorithm is configured for the first subnode, the receiving module is further configured to receive a second data model from the first subnode, and the second data model is obtained by training the first data model based on the first data set or the subset of the first data set; and a processing module, configured to update the first data model based on the second data model to obtain a target data model, where the sending module is further configured to send the target data model to the plurality of subnodes, and the plurality of subnodes include the first subnode.

In a possible design, the sending module is specifically configured to send, to the first subnode, at least one of parameter information and model structure information of the local first data model of the central node.

In a possible design, the receiving module is specifically configured to receive parameter information or gradient information of the second data model from the first subnode.

In a possible design, the processing module is specifically configured to: perform model convergence on the second data model and the first data model to obtain the target data model; or converge the second data model with the first data model to obtain a third data model, and train the third data model based on the first data set or the subset of the first data set to obtain the target data model.

In a possible design, the sending module is further specifically configured to: preferentially send the first data model based on a capacity of a communication link for sending data; and if a remaining capacity of the communication link is insufficient to meet a data volume of the first data set, randomly and evenly sample data in the first data set based on the remaining capacity of the communication link to obtain the subset of the first data set, and send the subset of the first data set to the first subnode.

In a possible design, if the data subset of the subnode includes a status parameter and a benefit parameter of the subnode, the receiving module is further specifically configured to receive a status parameter from a second subnode; the processing module is configured to input the status parameter into the local first data model of the central node, to obtain an output parameter corresponding to the status parameter; the sending module is configured to send the output parameter to the second subnode, so that the second subnode performs a corresponding action based on the output parameter; and the receiving module is further configured to receive a benefit parameter from the second subnode, where the benefit parameter indicates a feedback obtained by performing the corresponding action based on the output parameter.

According to a sixth aspect, a data model training apparatus is provided. An artificial intelligence AI algorithm is configured for the apparatus. The apparatus includes: a receiving module, configured to receive a first data model and a first data set or a subset of the first data set from a central node, where the first data set is generated by the central node by converging data subsets from a plurality of subnodes; a processing module, configured to train the first data model based on the first data set or the subset of the first data set, to obtain a second data model; and a sending module, configured to send the second data model to the central node, where the receiving module is further configured to receive a target data model from the central node, and the target data model is obtained by updating based on the second data model.

In a possible design, the receiving module is specifically configured to receive at least one of parameter information and model structure information of the first data model from the central node.

In a possible design, if a first subnode has a data collection capability, the processing module is specifically configured to: converge the first data set or the subset of the first data set with data locally collected by the first subnode, to obtain a second data set; and train the first data model based on the second data set, to obtain the second data model.

In a possible design, the sending module is specifically configured to send parameter information or gradient information of the second data model to the central node.

According to a seventh aspect, a data model training apparatus is provided. The apparatus includes: a sending module, configured to send a first data model to a first subnode, where an artificial intelligence AI algorithm is configured for the first subnode; a receiving module, configured to receive a second data model from the first subnode, where the second data model is obtained by training the first data model based on local data of the first subnode; and a processing module, configured to update the first data model based on the second data model to obtain a third data model, where the receiving module is further configured to: receive data subsets from a plurality of subnodes, and perform data convergence based on the plurality of data subsets to obtain a first data set; and the processing module is further configured to: train the third data model based on the first data set to obtain a target data model, and send the target data model to the plurality of subnodes, where the plurality of subnodes include the first subnode.

In a possible design, the sending module is specifically configured to send, to the first subnode, at least one of parameter information and model structure information of the local first data model of the central node.

In a possible design, that the receiving module is specifically configured to receive the second data model from the first subnode specifically includes: The receiving module is configured to receive parameter information or gradient information of the second data model from the first subnode.

In a possible design, that the processing module is specifically configured to update the first data model based on the second data model to obtain the third data model specifically includes: The processing module is specifically configured to perform model convergence on the second data model and the first data model to obtain the third data model.

In a possible design, if the data subset of the subnode includes a status parameter and a benefit parameter of the subnode, the receiving module is specifically configured to receive a status parameter from a second subnode; the processing module is configured to input the status parameter into the local first data model of the central node, to obtain an output parameter corresponding to the status parameter; the sending module is configured to send the output parameter to the second subnode, so that the second subnode performs a corresponding action based on the output parameter; and the receiving module is configured to receive a benefit parameter from the second subnode, where the benefit parameter indicates a feedback obtained by performing the corresponding action based on the output parameter.

According to an eighth aspect, a data model training apparatus is provided. An artificial intelligence AI algorithm is configured for the apparatus. The apparatus includes: a receiving module, configured to receive a first data model from a central node; a processing module, configured to train the first data model based on local data of the apparatus, to obtain a second data model; and a sending module, configured to send the second data model to the central node, where the receiving module is further configured to receive a target data model from the central node, and the target data model is obtained by updating based on the second data model.

In a possible design, the receiving module is specifically configured to receive at least one of parameter information and model structure information of the first data model from the central node.

In a possible design, the sending module is specifically configured to send parameter information or gradient information of the second data model to the central node.

According to a ninth aspect, a communication apparatus is provided. The communication apparatus includes a processor, and the processor is coupled to a memory. The memory is configured to store a computer program or instructions. The processor is configured to execute the computer program or the instructions stored in the memory, to enable the communication apparatus to perform the method according to any one of the first aspect.

According to a tenth aspect, a communication apparatus is provided. The communication apparatus includes a processor, and the processor is coupled to a memory. The memory is configured to store a computer program or instructions. The processor is configured to execute the computer program or the instructions stored in the memory, to enable the communication apparatus to perform the method according to any one of the second aspect.

According to an eleventh aspect, a communication apparatus is provided. The communication apparatus includes a processor, and the processor is coupled to a memory. The memory is configured to store a computer program or instructions. The processor is configured to execute the computer program or the instructions stored in the memory, to enable the communication apparatus to perform the method according to any one of the third aspect.

According to a twelfth aspect, a communication apparatus is provided. The communication apparatus includes a processor, and the processor is coupled to a memory. The memory is configured to store a computer program or instructions. The processor is configured to execute the computer program or the instructions stored in the memory, to enable the communication apparatus to perform the method according to any one of the fourth aspect.

According to a thirteenth aspect, a computer-readable storage medium is provided. When instructions in the computer-readable storage medium are executed by a processor of an electronic device, the electronic device is enabled to perform the method according to any one of the first aspect.

According to a fourteenth aspect, a computer-readable storage medium is provided. When instructions in the computer-readable storage medium are executed by a processor of an electronic device, the electronic device is enabled to perform the method according to any one of the second aspect.

According to a fifteenth aspect, a computer-readable storage medium is provided. When instructions in the computer-readable storage medium are executed by a processor of an electronic device, the electronic device is enabled to perform the method according to any one of the third aspect.

According to a sixteenth aspect, a computer-readable storage medium is provided. When instructions in the computer-readable storage medium are executed by a processor of an electronic device, the electronic device is enabled to perform the method according to any one of the fourth aspect.

According to a seventeenth aspect, a computer program product is provided. When the computer program product runs on a computer, the computer is enabled to perform the method according to any one of the first aspect.

According to an eighteenth aspect, a computer program product is provided. When the computer program product runs on a computer, the computer is enabled to perform the method according to any one of the second aspect.

According to a nineteenth aspect, a computer program product is provided. When the computer program product runs on a computer, the computer is enabled to perform the method according to any one of the third aspect.

According to a twentieth aspect, a computer program product is provided. When the computer program product runs on a computer, the computer is enabled to perform the method according to any one of the fourth aspect.

According to a twenty-first aspect, a machine learning system is provided. The machine learning system includes the apparatus according to any one of the fifth aspect and the apparatus according to any one of the sixth aspect.

According to a twenty-second aspect, a machine learning system is provided. The machine learning system includes the apparatus according to any one of the seventh aspect and the apparatus according to any one of the eighth aspect.

It may be understood that any one of the data model training apparatus, the computer-readable storage medium, the computer program product that are provided above may be implemented by using the corresponding method provided above. Therefore, for beneficial effects that can be achieved, refer to the beneficial effects in the corresponding method provided above. Details are not described herein again.

### BRIEF DESCRIPTION OF DRAWINGS

FIG. 1 is a diagram of a system architecture of a machine learning system according to an embodiment of this application;

FIG. 2 is a diagram of a hardware architecture of an electronic device according to an embodiment of this application;

FIG. 3 is a schematic flowchart of a data model training method according to an embodiment of this application;

FIG. 4 is a schematic diagram of data processing of a data model training method according to an embodiment of this application;

FIG. 5 is a schematic diagram of data processing of another data model training method according to an embodiment of this application;

FIG. 6 is a schematic flowchart of another data model training method according to an embodiment of this application;

FIG. 7 is a schematic diagram of data processing of another data model training method according to an embodiment of this application;

FIG. 8 is a schematic diagram of data processing of another data model training method according to an embodiment of this application; and

FIG. 9 is a schematic diagram of a structure of a data model training apparatus according to an embodiment of this application.

### DESCRIPTION OF EMBODIMENTS

The following terms “first” and “second” are merely intended for a purpose of description, and shall not be understood as an indication or implication of relative importance or implicit indication of a quantity of indicated technical features. Therefore, a feature limited by “first” or “second” may explicitly or implicitly include one or more features. In the descriptions of embodiments, unless otherwise specified, “a plurality of” means two or more.

It should be noted that, in this application, terms such as “example” or “for example” are used to represent giving an example, an illustration, or a description. Any embodiment or design scheme described as “example” or “for example” in this application should not be explained as being more preferred or having more advantages than another embodiment or design scheme. Exactly, use of the terms such as “example” or “for example” is intended to present a related concept in a specific manner.

The following clearly and completely describes the technical solutions in embodiments of this application with reference to the accompanying drawings in embodiments of this application. It is clear that, the described embodiments are merely some but not all of the embodiments of this application. All other embodiments obtained by a person of ordinary skill in the art based on embodiments of this application without creative efforts shall fall within the protection scope of this application.

First, an implementation environment and an application scenario of the embodiments of this application are briefly described.

This application may be applied to a communication system that can implement a machine learning algorithm such as distributed learning and federated learning, to implement a task of supervised learning, unsupervised learning, or reinforcement learning. The supervised learning is usually referred to as classification. A data model (which may be a set of a function or a neural network) may be obtained through training by using an existing training sample (that is, known data and an output corresponding to the training sample), so that an electronic device may perform inference computing by using the data model, that is, map an input to a corresponding output, to complete a capability of classifying data. The unsupervised learning is usually referred to as clustering, and refers to directly modeling data without a training sample. In other words, a classification result can be obtained by converging data of a similar characteristic. The reinforcement learning requires that a data model can obtain a corresponding behavior manner based on input data, and emphasizes an interaction process between a behavior of the electronic device and an implementation state, to obtain a maximum expected benefit and obtain an optimal behavior manner through learning. For a specific reinforcement learning algorithm process, refer to related technical descriptions. The following implementations of this application are described with reference to a distributed federated learning architecture. Details are not described herein.

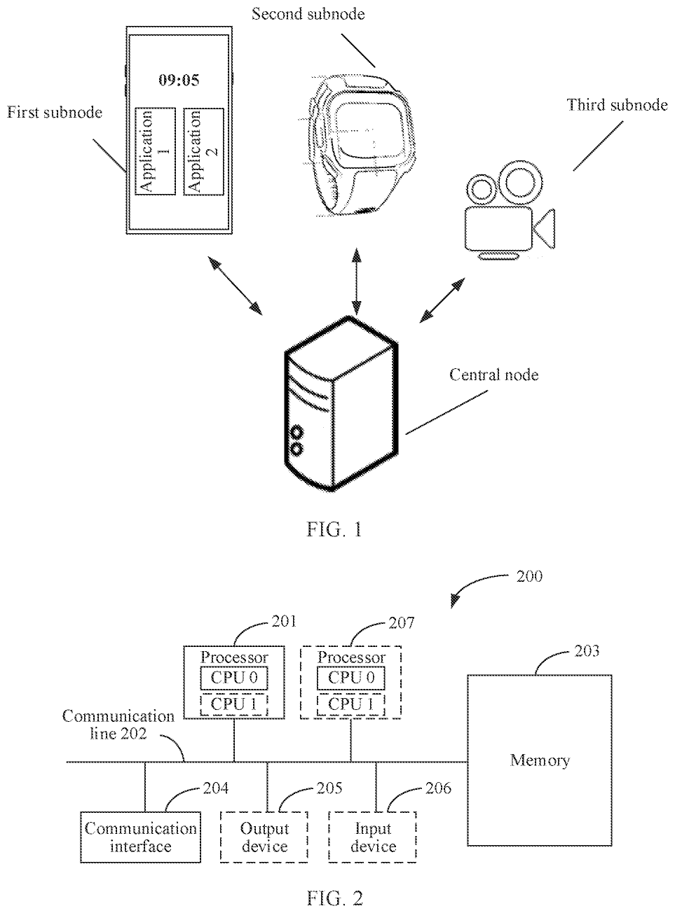

For example, embodiments of this application may be applied to a machine learning system of mobile edge computing (MEC) shown in FIG. 1. The machine learning system may include a central node and a plurality of distributed nodes.

The MEC is a technology that deeply integrates a mobile access network and an internet service. By using a radio access network to provide a required network service and a cloud computing function for a user nearby, the MEC is applicable to a carrier-grade service environment with high performance, a low delay, and high bandwidth. This can accelerate fast download of various content, services, and applications in a network, so that the user enjoys uninterrupted high-quality network experience.

A central node in FIG. 1 may be an edge server in a mobile edge computing system, and can be configured to implement data collection, data convergence, and data storage of an edge electronic device. An artificial intelligence (AI) algorithm is configured for the central node. The central node can perform AI training in an edge learning scenario to obtain a data model, and may perform processing such as data model convergence and update based on data models trained by a plurality of distributed nodes.

The plurality of distributed nodes are edge electronic devices, and may collect data, so that the central node or some distributed nodes having a training function can perform training based on a large quantity of data, to obtain a corresponding data model, and provide a service such as decision making or AI computing for the user.

Specifically, the distributed node may include a camera that collects video and image information, a sensor device that collects perception information, and the like. Alternatively, the distributed node may further include an electronic device that has a simple computing capability, such as an in-vehicle electronic device, a smartwatch, a smart sound box, or a wearable device. Alternatively, the distributed node may further include an electronic device that has a strong computing capability and a communication requirement, such as a computer, a notebook computer, a tablet computer, or a smartphone.

The distributed nodes may be classified into several different types based on different device computing capabilities. For example, based on whether the distributed nodes have training and inference computing capabilities, the distributed nodes may be classified into type-I subnodes, type-II subnodes, and type-III subnodes. For example, a first subnode included in FIG. 1 may be a type-I subnode, a second subnode may be a type-II subnode, and a third subnode may be a type-III subnode.

A type-I distributed node may be a device that has a strong computing capability and a communication requirement, such as an intelligent collection device, a notebook computer, or a smartphone. An AI algorithm is configured for the type-I distributed node. The type-I distributed node can perform training and perform inference computing based on a data model. A type-II distributed node may be some devices having a simple computing capability, such as an in-vehicle electronic device and a wearable device. The type-II distributed node may collect data, have a specific communication requirement and computing capability. An AI algorithm is configured for the type-II distributed node. The type-II distributed node can perform inference computing based on a delivered data model, but has no training capability. A type-III distributed node may be a camera that collects video and image information and a sensor device that collects perception information. A main function of the type-III distributed node is to collect local data. The type-III distributed node has a low communication requirement. An AI algorithm is not configured for the type-III distributed node. The type-III distributed node cannot perform training or inference computing.

It should be noted that, the machine learning system shown in FIG. 1 is merely used as an example, but not intended to limit the technical solutions of this application. A person skilled in the art should understand that, in a specific implementation process, the machine learning system may further include another device, and a device type of the central node or the distributed node and a quantity of the central nodes or the distributed nodes may be determined based on a specific requirement. Each network element in FIG. 1 may perform data transmission and communication through a communication interface.

Optionally, in embodiments of this application, each node in FIG. 1, for example, the central node or the distributed node, may be an electronic device or a functional module in an electronic device. It may be understood that the function may be a network component in a hardware device, for example, a communication chip in a mobile phone, may be a software function running on dedicated hardware, or may be a virtualized function instantiated on a platform (for example, a cloud platform).

In addition, the machine learning system in this application may be deployed in a communication system, or may be deployed on an electronic device. In other words, in an implementation, the central node and the plurality of distributed nodes in the machine learning system may alternatively be integrated into a same electronic device, for example, a server or a storage device, to perform distributed learning to optimize a data model. An implementation of the machine learning system is not specifically limited in this application.

For example, each node in FIG. 1 may be implemented by using an electronic device 200 in FIG. 2. FIG. 2 is a schematic diagram of a hardware structure of a communication apparatus that may be used in embodiments of this application. The electronic device 200 includes at least one processor 201, a communication line 202, a memory 203, and at least one communication interface 204.

The processor 201 may be a general-purpose central processing unit (CPU), a microprocessor, an application-specific integrated circuit (ASIC), or one or more integrated circuits configured to control execution of programs in the solutions in this application.

The communication line 202 may include a path, for example, a bus, for transmitting information between the foregoing components.

The communication interface 204 is configured to communicate with another device or a communication network by using any apparatus such as a transceiver, and is, for example, an Ethernet interface, a radio access network (RAN) interface, or a wireless local area network (WLAN) interface.

The memory 203 may be a read-only memory (ROM) or another type of static storage device that can store static information and instructions, a random access memory (RAM) or another type of dynamic storage device that can store information and instructions, an electrically erasable programmable read-only memory (EEPROM), a compact disc read-only memory (CD-ROM) or another compact disc storage, an optical disc storage (including a compact disc, a laser disc, an optical disc, a digital versatile disc, a Blu-ray disc, or the like), a magnetic disk storage medium or another magnetic storage device, or any other medium that can be used to carry or store expected program code in a form of an instruction or a data structure and that is accessible by a computer, but is not limited thereto. The memory may exist independently, and is connected to the processor through the communication line 202. The memory may alternatively be integrated with the processor. The memory provided in embodiments of this application may be usually non-volatile. The memory 203 is configured to store computer-executable instructions for executing the solutions in this application, and execution is controlled by the processor 201. The processor 201 is configured to execute the computer-executable instructions stored in the memory 203, to implement a method provided in embodiments of this application.

Optionally, the computer-executable instructions in embodiments of this application may also be referred to as application program code. This is not specifically limited in embodiments of this application.

In specific implementation, in an embodiment, the processor 201 may include one or more CPUs such as a CPU 0 and a CPU 1 in FIG. 2.

In specific implementation, in an embodiment, the electronic device 200 may include a plurality of processors, for example, the processor 201 and a processor 207 in FIG. 2. Each of the processors may be a single-core (single-CPU) processor, or may be a multi-core (multi-CPU) processor. The processor herein may be one or more devices, circuits, and/or processing cores configured to process data (for example, computer program instructions).

In specific implementation, in an embodiment, the electronic device 200 may further include an output device 205 and an input device 206. The output device 205 communicates with the processor 201, and may display information in a plurality of manners. For example, the output device 205 may be a liquid crystal display (LCD), a light emitting diode (LED) display device, a cathode ray tube (CRT) display device, or a projector. The input device 206 communicates with the processor 201, and may receive an input from a user in a plurality of manners. For example, the input device 206 may be a mouse, a keyboard, a touchscreen device, or a sensor device.

The electronic device 200 may be a general-purpose device or a dedicated device. In specific implementation, the electronic device 200 may be a desktop computer, a portable computer, a network server, a palmtop computer (PDA), a mobile phone, a tablet computer, a wireless terminal device, an embedded device, an augmented reality (AR)/virtual reality (VR) device, a vehicle, an in-vehicle module, an in-vehicle computer, an in-vehicle chip, an in-vehicle communication system, a wireless terminal in industrial control, or an electronic device having a structure similar to that in FIG. 2. A type of the electronic device 200 is not limited in this embodiment of this application.

The following specifically describes the data model training method provided in embodiments of this application with reference to FIG. 1 and FIG. 2.

This application provides a distributed data model training method. A central node collects data collected from a plurality of distributed nodes. The central node and some distributed nodes having a training capability collaboratively complete training based on a global data set of a machine learning system, perform convergence processing on data models generated by the plurality of nodes, and finally obtain a global data model of a machine learning system through a plurality of rounds of data model iteration. This avoids a problem that performance of a data model obtained through training by a single node based on a data set with a non-independent and identically distributed characteristic is poor, and improves performance and efficiency of deep learning.

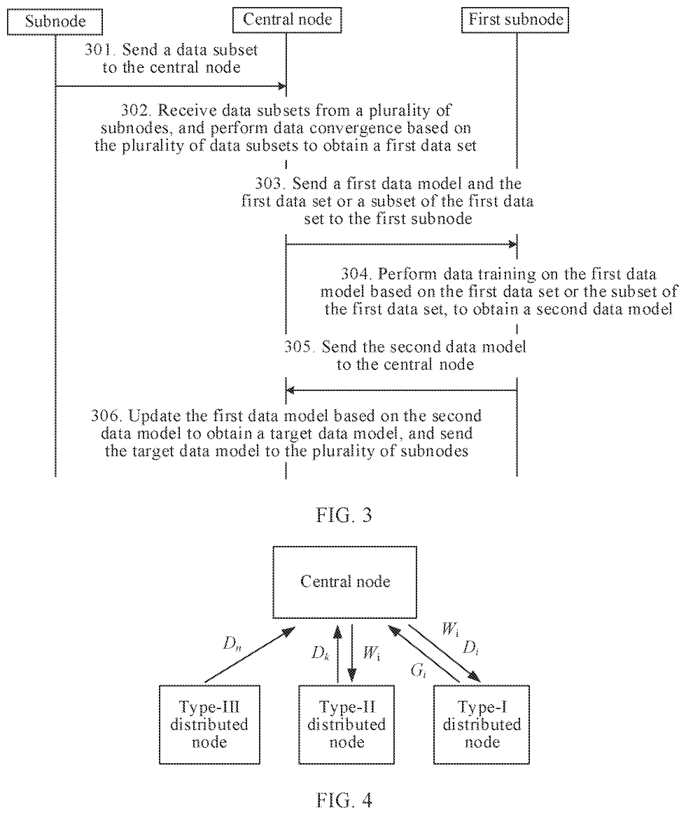

As shown in FIG. 3, when the method is applied to a communication system, the method includes the following content.

301. A subnode sends a data subset to a central node.

At least one subnode collects device data to establish the data subset, and uploads the data subset to the central node.

The device data may be data information collected by an electronic device corresponding to the subnode, for example, status information of the electronic device, application data generated by an application, motion track information, image information, or network traffic information.

It should be noted that, the collected device data may vary based on different implementation tasks of a data model. For example, an implementation task of the data model is to make a decision on scheduling of a radio resource in the communication system. In this case, the device data collected by the subnode may include information such as channel quality of the subnode and a quality of service indicator of communication. In this way, a data model may be established based on channel quality of each subnode, communication quality of service indicators, and the like, and a large amount of training may be performed. For example, reinforcement learning modeling may be implemented based on a Markov decision process (MDP) algorithm.

In this embodiment of this application, the implementation task of the data model and a type of the collected device data are not specifically limited. Specifically, a machine learning model may be constructed and device data may be collected and reported based on an implementation task requirement of the data model. In addition, the subnode and the central node may pre-configure a structure and an algorithm of a neural network model, or may negotiate or notify the structure of the neural network model at the beginning of training.

The subnode may include a type-I distributed node, a type-II distributed node, or a type-III distributed node in the foregoing communication system. When the subnode uploads a local data subset to the central node, a throughput capacity of a current communication link also needs to be considered. When a data volume of the local data subset is greater than a link capacity, the subnode may randomly and evenly sample the local data subset, and upload a data subset obtained through sampling.

It should be noted that a data distribution characteristic of the data sample obtained through random and even sampling is the same as that of the original data set.

302. The central node receives data subsets from a plurality of subnodes, and performs data convergence based on the plurality of data subsets to obtain a first data set.

The central node may perform data convergence on the device data collected by the plurality of subnodes, to obtain a global data set, that is, the first data set.

It should be noted that, the data subset of the subnode and the device data in the first data set may meet an independent and identically distributed characteristic, or may not meet the independent and identically distributed characteristic. The technical solution of this application can be implemented in both cases. This is not specifically limited in this application.

303. The central node sends a first data model and the first data set or a subset of the first data set to a first subnode.

The first subnode may be a type-I distributed node in the foregoing communication system. The first subnode may be specifically an electronic device for which a neural network algorithm is configured, and has a capability of training the neural network model and performing inference computing based on a data model.

In addition, the first subnode may be further configured to collect device data to obtain a data subset corresponding to the first subnode, and is configured to perform training based on the data subset to obtain a data model.

It should be noted that in this embodiment of this application, the first data model is a global neural network model of the communication system. The first data model is generated in a process in which the central node and at least one type-I distributed node perform training in collaboration. Training of the first data model ends until the first data model meets a convergence condition or until a completed training round meets a specific condition through a plurality of rounds of repeated training and parameter iteration and update. The first data model of the central node is updated to a final target data model. Therefore, the first data model in this embodiment of this application is a local global data model of the central node in an i^{th} round of a training process.

In an implementation, before step 303, when the central node starts training, the central node may first initialize a parameter of a neural network, for example, randomly generate an initial configuration parameter of the neural network. Then, an initial data model is sent to the first subnode. Specifically, information such as a model structure and an initial configuration parameter corresponding to the initial data model may be sent. In this way, the first subnode may obtain, based on the model structure, the initial configuration parameter, and the like, the initial data model synchronized with the central node, to perform collaborative training of the global data model.

In addition, the central node further needs to deliver the global data set to the first subnode for training. The delivered global data set may be the first data set, or may be the subset of the first data set.

The subset of the first data set is obtained by randomly and evenly sampling the first data set. Therefore, a data distribution characteristic of the subset of the first data set is consistent with that of the first data set. For example, if data in the first data set meets the independent and identically distributed characteristic, data in the subset of the first data set also meets the independent and identically distributed characteristic.

In an implementation, considering a throughput capacity of a communication link between the central node and the first subnode, the central node may preferentially send the first data model based on a capacity of a communication link for sending data; and if a remaining capacity of the communication link is insufficient to meet a data volume of the first data set, the central node randomly and evenly samples data in the first data set based on the remaining capacity of the communication link to obtain the subset of the first data set.

Specifically, in the i^{th} round of the training process, the central node may determine, according to the following principles and based on the capacity of the communication link, to send the first data model to the first subnode, and send the first data set or the subset of the first data set.

1. When the capacity of the communication link is greater than or equal to a sum of a data volume of the first data model and the data volume of the first data set, the central node sends the first data model and the first data set to the subnode.

For example, when I≥I_{W}+I_{D}, the central node sends the first data model and the first data set to the subnode. The data volume of the first data model is I_{W}, and the data volume of the first data set is I_{D}.

2. When the capacity of the communication link is less than the sum of the data volume of the first data model and the data volume of the first data set, and the capacity of the communication link is greater than or equal to the first data model, the central node sends the first data model and the subset of the first data set to the subnode.

For example, when I<I_{W}+I_{D} and I≥I_{W}, the central node sends the first data model and a subset D1 of the first data set to the subnode, where I_{D1}=I−I_{W}. The data volume of the first data model is I_{W}, a data volume of the subset D1 of the first data set is I_{D1}, and the data volume of the first data set D is I_{D}.

The subset D1 of the first data set includes q pieces of sample data randomly and evenly sampled from the first data set D, where q=floor (I_{D}/I_{S}), and I_{S} represents a data volume of each element in the first data set. A function of a floor (x) function is rounding down, that is, to obtain a maximum integer not greater than x, that is, a maximum integer in integers that are less than or equal to x.

3. When the capacity of the communication link is equal to the data volume of the first data model, the central node sends the first data model to the subnode. In other words, a data set for training may not be sent in this round, and the first data set or the subset of the first data set is sent in a next round.

For example, when I=I_{W}, the central node only sends the first data model to the subnode.

4. When the capacity of the communication link is less than the data volume of the first data model, the central node sends the subset of the first data set to the subnode, but does not send the first data model.

For example, when I<I_{W}, the central node sends a subset D2 of the first data set to the subnode, where the subset D2 of the first data set includes q pieces of sample data randomly and evenly sampled from the first data set D, q=floor (I/I_{S}), and I_{S} represents a data volume of each element in the first data set.

304. The first subnode trains the first data model based on the first data set or the subset of the first data set, to obtain a second data model.

The first subnode may perform training based on global data, to update the first data model to the second data model.

In addition, if the first subnode itself has a capability of collecting device data, the first subnode may first perform data convergence on a locally collected data subset and the first data set or the subset of the first data set delivered by the central node, to obtain the second data set. Then, the first data model is trained based on the second data set obtained through the data convergence. After local training ends, an obtained data model is the second data model.

It should be noted that, similar to the content indicated by the first data model, the second data model in this embodiment of this application is a local data model of the first subnode in the i^{th} round of the training process. The second data model also updates a model parameter in a plurality of rounds of repeated training until the training is completed.

305. The first subnode sends the second data model to the central node.

After completing this round of training, the first subnode reports the obtained second data model to the central node, which may specifically include: The first subnode sends parameter information or gradient information of the second data model to the central node.

The neural network algorithm generally includes a multi-layer algorithm. The parameter information of the second data model includes a plurality of pieces of parameter information corresponding to a multi-layer network in a neural network corresponding to the second data model. The gradient information is an information set including gradient values of parameters of the second data model. For example, the gradient value may be obtained by performing derivation on a loss function by using the parameter of the second data model. For specific gradient information computing, refer to a related algorithm. This is not specifically limited in this application. Therefore, the central node may obtain the second data model based on the parameter information of the second data model, or the central node may obtain the second data model based on the first data model in combination with the gradient information of the second data model.

306. The central node updates the first data model based on the second data model to obtain the target data model, and sends the target data model to the plurality of subnodes.

The plurality of subnodes include the first subnode.

That the central node updates the local first data model based on the second data model reported by the first subnode may be specifically: The central node updates each parameter of the first data model to the parameter corresponding to the second data model, to obtain the target data model.

Alternatively, that the central node may update the first data model based on the second data model to obtain the target data model may specifically include: The central node performs model convergence on a plurality of second data models reported by a plurality of type-I distributed nodes and the first data model, to obtain the target data model.

Alternatively, that the central node may update the first data model based on the second data model to obtain the target data model may further specifically include: The central node may perform convergence on the plurality of second data models reported by the plurality of type-I distributed nodes and the first data model to obtain a third data model, and train the third data model based on the first data set or the subset of the first data set to obtain the target data model. In this way, the central node performs, based on the global data set, training again on the model obtained by training based on the distributed node. This can further improve performance of the data model.

In this embodiment of this application, the target data model is the global data model locally obtained on the central node in the i^{th} round of the training process. When an (i+1)^{th} round of training starts, that is, when the foregoing steps 301 to 306 continue to be performed in this application, it indicates that a next round of training is performed. In this case, the central node converges a plurality of collected data subsets reported by the plurality of subnodes into the first data set, and the central node repeatedly performs step 303 to deliver the first data set and the first data model to the at least one first subnode. In this case, the first data model is the target data model obtained through updating in step 306, that is, the target data model obtained in the i^{th} round is the first data model in the (i+1)^{th} round.

In a process in which the central node and the at least one type-I distributed node perform training in collaboration, training of the target data model ends until the target data model meets a convergence condition or until a completed training round meets a specific condition through a plurality of rounds of repeated training and parameter iteration and update. The target data model obtained by the central node in step 306 is the final target data model. The central node delivers the target data model to the plurality of subnodes, so that the subnode locally inputs the target data model based on the device data to complete inference computing.

In the foregoing implementation of this application, the central node collects the device data reported by the plurality of subnodes, so that the central node and the at least one type-I distributed node perform training in collaboration based on collected global device data, to avoid a problem in the conventional technology that data model performance is poor because the distributed node performs training based on a local data set. This improves performance of a machine learning algorithm and user experience.

It should be noted that, when the foregoing machine learning architecture in this application is actually deployed in a communication network, not all the three types of distributed nodes exist. For example, if there are no type-II and type-III distributed nodes, the machine learning architecture is degraded to a conventional federated learning structure. In this case, because there is no node that uploads local data, overall system performance is affected by a problem of a non-independent and identically distributed characteristic of data. In addition, the type-II and type-III distributed nodes need to upload device data, which may involve a problem of data privacy. The following method may be used to solve the problem: First, the type-II and type-III distributed nodes are deployed as specific nodes dedicated for data collection and arranged by a network operator. In this way, a purpose of data collection is to improve system performance, and the data itself does not carry privacy information. In addition, when the type-II and type-III distributed nodes are user devices, the device data may be encrypted by using an encryption method. For the encryption method, refer to a related technology. Details are not described in this embodiment of this application.

In an implementation, before step 301, the central node may select, from the communication network, a plurality of type-II distributed nodes or a plurality of type-III distributed nodes that are used to collect the device data, and select a plurality of type-I distributed nodes for training.

A specific method for selecting a distributed node by the central node may be random selection. Alternatively, the central node may select, based on communication link quality of the distributed node, several distributed nodes with better communication link quality for collaborative processing, or may select, based on a processing task of a data model, a distributed node that can collect specific device data corresponding to the processing task.

In addition, the type-II distributed node is a device having a simple computing capability. An AI algorithm is configured for the type-II distributed node. The type-II distributed node can perform inference computing based on a delivered data model. Therefore, in addition to collecting device data for the central node, the type-II distributed node may further perform inference computing based on local device data and the data model delivered by the central node.

For example, the central node selects N type-I distributed nodes for collaborative training, and selects K type-II distributed nodes and M type-III distributed nodes for collecting device data.

As shown in FIG. 4, in step 301 of the foregoing implementation, the K type-II distributed nodes and the M type-III distributed nodes may report local data subsets to the central node. In step 303 of the foregoing implementation, the central node may deliver the first data model Wᵢ and the first data set Dᵢ or the subset D1ᵢ of the first data set to the N type-I distributed nodes, so that the N type-I distributed nodes perform training to obtain the plurality of second data models Gᵢ, where i indicates a quantity of training rounds. In step 306 of the foregoing implementation, the central node may update, based on the N second data models reported by the N type-I distributed nodes, the first data model after performing data model convergence, to obtain the target data model, and complete the i^{th} round of the training process. Then, the (i+1)^{th} round of training starts. The target data model obtained in the i^{th} round is the first data model W in the (i+1)^{th} round. The central node delivers Wᵢ₊₁ and the global data set to the N type-I distributed nodes, and continues to perform training until the model converges or until a training round condition is met.

In addition, based on algorithm logic of reinforcement learning, the electronic device needs to collect a status parameter, and obtain a corresponding action parameter according to a specific decision policy. After performing the action, the electronic device collects a benefit parameter corresponding to the action performed by the electronic device. Through a plurality of iterations, the electronic device obtains, based on the status parameter, a data model for making an optimal action decision.

In another implementation scenario provided in this embodiment of this application, when the communication system includes a distributed federated learning task for reinforcement learning modeling, that is, the distributed node needs to collect a local status parameter and a local benefit parameter, so that the distributed node and the central node perform training in collaboration, to obtain an optimal data model.

In an implementation, the central node selects N type-I distributed nodes for collaborative training, and selects K type-II distributed nodes and M type-III distributed nodes for collecting device data. An AI algorithm is locally configured for the type-I distributed node and the type-II distributed node. The type-I distributed node and the type-II distributed node have a data inference capability. Therefore, the type-I distributed node and the type-II distributed node may perform inference based on a status parameter and a data model delivered by the central node to obtain a corresponding action, and then obtain a benefit parameter after performing the action, to report a plurality of groups of collected status parameters and corresponding benefit parameters to the central node.

However, no AI algorithm is configured for the type-III distributed node, and the type-III distributed node does not have a training capability or an inference computing capability. Therefore, the central node needs to be used to implement inference computing, to obtain a corresponding benefit parameter based on a status parameter of a subnode.

For example, a third subnode belongs to the foregoing type-III distributed node. In this case, in steps 301 and 302 in the foregoing implementation, the data subset collected by the subnode includes a status parameter and a benefit parameter of the subnode. That the central node receives a data subset from the third subnode may specifically include:
Step 1. The third subnode collects the status parameter to obtain the data subset, and sends the data subset to the central node.
Step 2. The central node obtains the status parameter from the third subnode, and inputs the status parameter into the local first data model of the central node, to obtain an output parameter corresponding to the status parameter.

In other words, the central node inputs the status parameter of the third subnode into the first data model for decision-making, to obtain an action corresponding to the status parameter. The action is also referred to as the output parameter corresponding to the status parameter.
Step 3. The central node sends the output parameter to the third subnode.
Step 4. The third subnode performs the corresponding action based on the output parameter, to obtain the benefit parameter corresponding to the output parameter.
Step 5. The third subnode reports the benefit parameter to the central node. The benefit parameter indicates feedback information obtained by the third subnode after the corresponding action is performed based on the output parameter.
Step 6. The central node receives the benefit parameter from the third subnode.

In an implementation, the reinforcement learning algorithm in the foregoing implementation may be specifically a deep reinforcement learning algorithm of actor critic. For example, an actor neural network and a critic neural network may be separately configured on the distributed node or the central node that is used for training in the communication system.

The actor neural network is responsible for making a decision based on the status parameter (Sₙ) to obtain a corresponding action (Aₙ). The critic neural network is responsible for evaluating, based on the status parameter (Sₙ) and the benefit parameter (Rₙ) fed back after a device performs the action (Aₙ), advantages and disadvantages of an action (Aₙ) decision made by the actor neural network. The actor neural network modulates its own decision-making policy based on the evaluation of the critic neural network, to output a better action decision and obtain better system performance. In a deep reinforcement learning framework, both the actor and the critic may be implemented by a deep neural network.

As shown in FIG. 5, because the type-I distributed node has training and data inference capabilities, the actor neural network and the critic neural network need to be deployed. The type-I distributed node may be configured to perform training based on data sets S and R delivered by the central node and the first data model Wᵢ, to obtain a local second data model Gᵢ of the type-I distributed node, and report the second data model to the central node for global data model convergence, to perform a next round of training.

The type-II distributed node has only the data inference capability but not the training capability, and only the actor neural network needs to be deployed. The type-II distributed node may be configured to collect a local status parameter and a corresponding benefit parameter. Specifically, the type-II distributed node receives the first data model Wᵢ delivered by the central node, inputs the first data model Wᵢ based on the local status parameter Sₙ to obtain a corresponding execution action Aₙ, and obtains the benefit parameter Rₙ based on a feedback obtained based on the action Aₙ. In this case, the type-II distributed node may repeat the foregoing actions for a plurality of times, collect the status parameter Sₙ and the benefit parameter Rₙ, and obtain corresponding data sets S and R respectively. The type-II distributed node may report the data sets S and R to the central node, to collect global data to complete global training.

The type-III distributed node does not have the training and data inference capabilities. Therefore, a neural network does not need to be deployed. The type-III distributed node may be configured to collect a local status parameter and a corresponding benefit parameter. Inference computing may be implemented by using the central node. To be specific, the type-III distributed node reports the status parameter Sₙ to the central node, the central node obtains the corresponding execution action Aₙ based on the first data model Wᵢ, the central node delivers the action Aₙ to the type-III distributed node, and the type-III distributed node obtains the benefit parameter Rₙ based on a feedback obtained based on the action Aₙ. For details, refer to the foregoing Step 1 to Step 6.

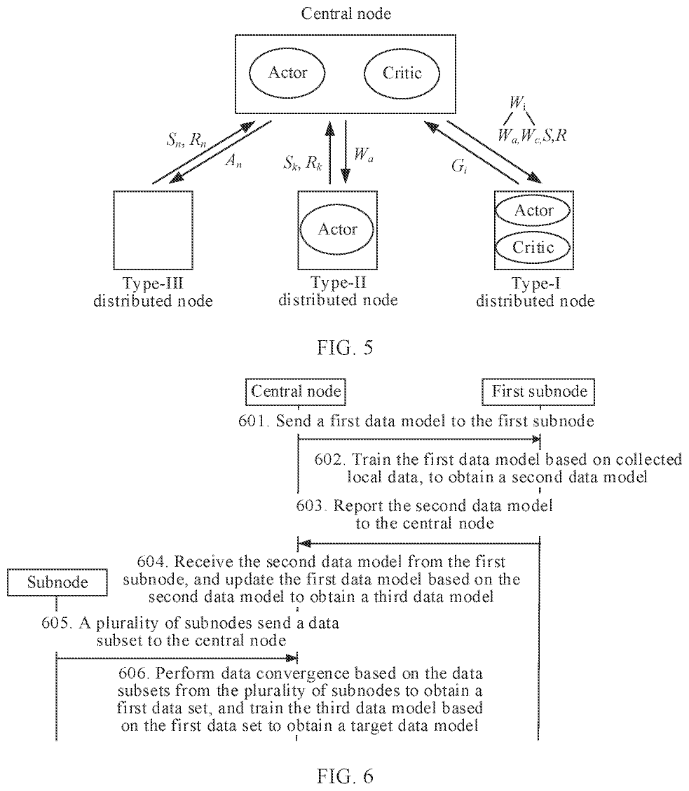

In addition, considering resource occupation and real-time performance problems caused by network bandwidth occupied when the central node frequently delivers the global data set to the type-I distributed node, this application further provides an implementation. The central node delivers only the global data model, but does not deliver the global data set, to implement distributed data management. As shown in FIG. 6, the implementation specifically includes the following steps.

601. A central node sends a first data model to a first subnode.

An artificial intelligence AI algorithm is configured for the first subnode, and the artificial intelligence AI algorithm can be used for training.

602. The first subnode trains the first data model based on collected local data, to obtain a second data model.

603. The first subnode reports the second data model to the central node.

604. The central node receives the second data model from the first subnode, and updates the first data model based on the second data model to obtain a third data model.

605. A plurality of subnodes send a data subset to the central node.

606. The central node performs data convergence based on the data subsets from the plurality of subnodes to obtain a first data set, and trains the third data model based on the first data set to obtain a target data model.

Similar to the foregoing embodiment, the first data model in this embodiment of this application is a local data model of the central node in an i^{th} round of a training process. In this case, in the i^{th} round of the training process, the obtained target data model becomes the first data model in an (i+1)^{th} round, training of the target data model ends until the target data model meets a convergence condition or until a completed training round meets a specific condition by repeatedly performing the foregoing steps 601 to 604. The target data model of the central node is updated to the final target data model.

According to the foregoing implementation of this application, at least one type-I distributed node trains, based on the local data, a data model delivered by the central node, and reports an obtained local data model to the central node. The central node collects device data reported by the plurality of subnodes, so that the central node performs, based on a global data set, global training on a data model collected by the at least one type-I distributed node. The global data model delivered by the central node is obtained through training based on the global data set, and the type-I distributed node updates the local data model by using the global data model, to avoid a problem in the conventional technology that data model performance is poor because the distributed node performs training based on a local data set. This improves performance of a machine learning algorithm and user experience.

In an implementation, before step 605, the central node may select, from a communication network, a plurality of type-II distributed nodes or a plurality of type-III distributed nodes that are used to collect the device data, and select a plurality of type-I distributed nodes for training.

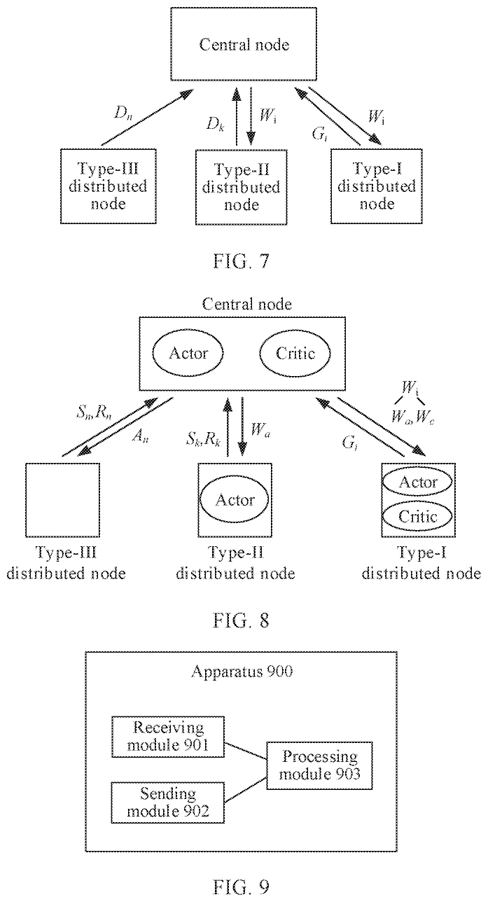

As shown in FIG. 7, in the foregoing implementation, the central node may deliver the first data model Wᵢ to the type-I distributed node, so that the type-I distributed node performs training to obtain the second data model Gᵢ and reports the second data model to the central node, where i represents a quantity of training rounds. The central node may collect data subsets Data 1 and Data 2 reported by the type-II distributed node and the type-III distributed node, to obtain the global data set D. In addition, the central node may perform model convergence on second data models reported by a plurality of type-I distributed nodes, and train a converged global data model based on the global data set D, to obtain a first data model Wᵢ₊₁ in a next round, until the model is converged to obtain a final global target data model.

In addition, the distributed data model training method shown in FIG. 6 is also applicable to the foregoing reinforcement learning scenario, in other words, the device data collected by the distributed node may include a status parameter and a benefit parameter, and is used by the distributed node and the central node to perform training in collaboration, to obtain an optimal data model.

In an implementation, the central node selects N type-I distributed nodes for collaborative training, and selects K type-II distributed nodes and M type-III distributed nodes for collecting device data. An AI algorithm is locally configured for the type-I distributed node and the type-II distributed node. The type-I distributed node and the type-II distributed node have a data inference capability. Therefore, the type-I distributed node and the type-II distributed node may perform inference based on the status parameter and a data model delivered by the central node to obtain a corresponding action, and then obtain a benefit parameter after performing the action, to report a plurality of groups of collected status parameters and corresponding benefit parameters to the central node.

However, no AI algorithm is configured for the type-III distributed node, and the type-III distributed node does not have a training capability or an inference computing capability. Therefore, the central node needs to be used to implement inference computing, to obtain a corresponding benefit parameter based on a status parameter of a subnode.

For example, a third subnode belongs to the foregoing type-III distributed node. In the implementation shown in FIG. 6, the data subset collected by the subnode includes the status parameter and the benefit parameter of the subnode. The central node receives a data subset from a third child node. For details, refer to the foregoing Step 1 to Step 6. Details are not described herein again.

Correspondingly, as shown in FIG. 8, the reinforcement learning algorithm in the foregoing implementation may be specifically a deep reinforcement learning algorithm of actorcritic.

Because the type-I distributed node has training and data inference capabilities, an actor neural network and a critic neural network need to be deployed. The type-I distributed node may be configured to train, based on a locally collected status parameter and a corresponding benefit parameter, the first data model Wᵢ delivered by the central node, to obtain a local second data model Gᵢ of the type-I distributed node, and report the second data model to the central node for global data model convergence, to perform a next round of training.

The type-II distributed node has only the data inference capability but not the training capability, and only the actor neural network needs to be deployed. The type-II distributed node may be configured to collect a local status parameter and a corresponding benefit parameter. Specifically, the type-II distributed node receives the first data model Wᵢ delivered by the central node, inputs the first data model Wᵢ based on the local status parameter Sₙ to obtain a corresponding execution action Aₙ, and obtains the benefit parameter Rₙ based on a feedback obtained based on the action Aₙ. In this case, the type-II distributed node may repeat the foregoing actions for a plurality of times, collect the status parameter Sₙ and the benefit parameter Rₙ, and obtain corresponding data sets S and R respectively. The type-II distributed node may report the data sets S and R to the central node, to collect global data to complete global training.

The type-III distributed node does not have the training and data inference capabilities. Therefore, a neural network does not need to be deployed. The type-III distributed node may be configured to collect a local status parameter and a corresponding benefit parameter. Inference computing may be implemented by using the central node. To be specific, the type-III distributed node reports the status parameter Sₙ to the central node, the central node obtains the corresponding execution action Aₙ based on the first data model Wᵢ, the central node delivers the action Aₙ to the type-III distributed node, and the type-III distributed node obtains the benefit parameter Rₙ based on a feedback obtained based on the action Aₙ. For details, refer to the foregoing Step 1 to Step 6.

It may be understood that a same step or a step or a message having a same function in several embodiments of this application may be mutually referenced in different embodiments.

Based on the distributed data management method, this application further provides a data model training apparatus. As shown in FIG. 9, the apparatus 900 includes a receiving module 901, a sending module 902, and a processing module 903.

The receiving module 901 may be configured to: receive data subsets from a plurality of subnodes, and perform data convergence based on the plurality of data subsets to obtain a first data set.

The sending module 902 may be configured to send a first data model and the first data set or a subset of the first data set to a first subnode. An artificial intelligence AI algorithm is configured for the first subnode.

The receiving module 901 may be further configured to receive a second data model from the first subnode. The second data model is obtained by training the first data model based on the first data set or the subset of the first data set.

The processing module 903 may be configured to update the first data model based on the second data model to obtain a target data model.

The sending module 902 may be further configured to send the target data model to the plurality of subnodes. The plurality of subnodes include the first subnode.

In a possible design, the sending module 902 is specifically configured to send, to the first subnode, at least one of parameter information and model structure information of the local first data model of the central node.

In a possible design, the receiving module 901 is specifically configured to receive parameter information or gradient information of the second data model from the first subnode.

In a possible design, the processing module 903 is specifically configured to: perform model convergence on the second data model and the first data model to obtain the target data model; or converge the second data model with the first data model to obtain a third data model, and train the third data model based on the first data set or the subset of the first data set to obtain the target data model.

In a possible design, the sending module 902 is further specifically configured to: preferentially send the first data model based on a capacity of a communication link for sending data; and if a remaining capacity of the communication link is insufficient to meet a data volume of the first data set, randomly and evenly sample data in the first data set based on the remaining capacity of the communication link to obtain the subset of the first data set, and send the subset of the first data set to the first subnode.

In a possible design, if the data subset of the subnode includes a status parameter and a benefit parameter of the subnode, the receiving module 901 is further specifically configured to receive a status parameter from a second subnode; the processing module 903 is configured to input the status parameter into the local first data model of the central node, to obtain an output parameter corresponding to the status parameter; the sending module 902 is configured to send the output parameter to the second subnode, so that the second subnode performs a corresponding action based on the output parameter; and the receiving module 901 is further configured to receive a benefit parameter from the second subnode, where the benefit parameter indicates a feedback obtained by performing the corresponding action based on the output parameter.

The apparatus 900 is configured to perform the steps performed by the central node in the implementation shown in FIG. 3. For specific content, refer to the foregoing implementation. Details are not described herein again.

In addition, this application further provides a data model training apparatus. An artificial intelligence AI algorithm is configured for the apparatus. The apparatus is configured to perform the steps performed by the first subnode in the implementation shown in FIG. 3. As shown in FIG. 9, the apparatus 900 includes a receiving module 901, a sending module 902, and a processing module 903.

The receiving module 901 is configured to receive a first data model and a first data set or a subset of the first data set from a central node. The first data set is generated by the central node by converging data subsets from a plurality of subnodes.

The processing module 903 is configured to train the first data model based on the first data set or the subset of the first data set, to obtain a second data model.

The sending module 902 is configured to send the second data model to the central node. The receiving module is further configured to receive a target data model from the central node. The target data model is obtained by updating based on the second data model.

In a possible design, the receiving module 901 is specifically configured to receive at least one of parameter information and model structure information of the first data model from the central node.

In a possible design, if the first subnode has a data collection capability, the processing module 903 is specifically configured to: converge the first data set or the subset of the first data set with data locally collected by the first subnode, to obtain a second data set; and train the first data model based on the second data set, to obtain the second data model.

In a possible design, the sending module 902 is specifically configured to send parameter information or gradient information of the second data model to the central node.

In addition, this application further provides a data model training apparatus. An artificial intelligence AI algorithm is configured for the apparatus. The apparatus is configured to perform the steps performed by the central node in the implementation shown in FIG. 6.

As shown in FIG. 9, the apparatus 900 includes a receiving module 901, a sending module 902, and a processing module 903.

The sending module 902 is configured to send a first data model to a first subnode. An artificial intelligence AI algorithm is configured for the first subnode.

The receiving module 901 is configured to receive a second data model from the first subnode. The second data model is obtained by training the first data model based on local data of the first subnode.

The processing module 903 is configured to update the first data model based on the second data model to obtain a third data model.

The receiving module 901 is further configured to: receive data subsets from a plurality of subnodes, and perform data convergence based on the plurality of data subsets to obtain a first data set.

The processing module 903 is further configured to: train the third data model based on the first data set to obtain a target data model, and send the target data model to the plurality of subnodes. The plurality of subnodes include the first subnode.

In a possible design, the sending module 902 is specifically configured to send, to the first subnode, at least one of parameter information and model structure information of the local first data model of the apparatus.

In a possible design, that the receiving module 901 is specifically configured to receive the second data model from the first subnode specifically includes: The receiving module 901 is configured to receive parameter information or gradient information of the second data model from the first subnode.

In a possible design, that the processing module 903 is specifically configured to update the first data model based on the second data model to obtain the third data model specifically includes: The processing module 903 is configured to perform model convergence on the second data model and the first data model to obtain the third data model.

In a possible design, if the data subset of the subnode includes a status parameter and a benefit parameter of the subnode, the receiving module 901 is specifically configured to receive a status parameter from a second subnode; the processing module is configured to input the status parameter into the local first data model of the central node, to obtain an output parameter corresponding to the status parameter; the sending module is configured to send the output parameter to the second subnode, so that the second subnode performs a corresponding action based on the output parameter; and the receiving module is configured to receive a benefit parameter from the second subnode, where the benefit parameter indicates a feedback obtained by performing the corresponding action based on the output parameter.

In addition, this application further provides a data model training apparatus. An artificial intelligence AI algorithm is configured for the apparatus. The apparatus is configured to perform the steps performed by the first subnode in the implementation shown in FIG. 6. As shown in FIG. 9, the apparatus 900 includes a receiving module 901, a sending module 902, and a processing module 903.

The receiving module 901 is configured to receive a first data model from a central node.

The processing module 903 is configured to train the first data model based on local data of the apparatus, to obtain a second data model.

The sending module 902 is configured to send the second data model to the central nod.

The receiving module 901 is further configured to receive a target data model from the central node. The target data model is obtained by updating based on the second data model.

In a possible design, the receiving module 901 is specifically configured to receive at least one of parameter information and model structure information of the first data model from the central node.

In a possible design, the sending module 902 is specifically configured to send parameter information or gradient information of the second data model to the central node.

It should be noted that, for a specific execution process and embodiment of the apparatus 900, refer to the steps performed by the central node and the first subnode and related descriptions in the foregoing method embodiments. For a resolved technical problem and brought technical effects, refer to the content described in the foregoing embodiments. Details are not described herein again.

In this embodiment, the apparatus is presented in a form of functional modules obtained through division in an integrated manner. The “module” herein may be a specific circuit, a processor and a memory that execute one or more software or firmware programs, an integrated logic circuit, and/or another component that can provide the foregoing functions. In a simple embodiment, a person skilled in the art may figure out that the apparatus may be in the form shown in FIG. 2.

For example, functions/implementation processes of the processing module in FIG. 9 may be implemented by the processor 201 in FIG. 2 by invoking the computer program instructions stored in the memory 203.

In an example embodiment, a computer-readable storage medium including instructions is further provided. The instructions may be executed by the processor 201 of the electronic device 200 to complete the method in the foregoing embodiments. Therefore, for technical effects that can be achieved by the computer-readable storage medium, refer to the foregoing method embodiments. Details are not described herein again.

All or some of the foregoing embodiments may be implemented by software, hardware, firmware, or any combination thereof. When a software program is used to implement embodiments, all or some of embodiments may be implemented in a form of a computer program product. The computer program product includes one or more computer instructions. When the computer program instructions are loaded and executed on a computer, all or some of the procedures or functions according to embodiments of this application are generated. The computer may be a general-purpose computer, a dedicated computer, a computer network, or another programmable apparatus.

An embodiment of this application further provides a computer storage medium. The computer storage medium includes computer instructions. When the computer instructions are run on the foregoing electronic device, the electronic device is enabled to perform functions or steps performed by the central node or various subnodes in the foregoing method embodiments.

An embodiment of this application further provides a computer program product. When the computer program product runs on a computer, the computer is enabled to perform functions or steps performed by the central node or various subnodes in the foregoing method embodiments.

The foregoing descriptions about implementations allow a person skilled in the art to clearly understand that, for the purpose of convenient and brief description, division of the foregoing functional modules is only used as an example for illustration. In actual application, the foregoing functions can be allocated to different functional modules and implemented based on a requirement, that is, an inner structure of an apparatus is divided into different functional modules to implement all or some of the functions described above.

In the several embodiments provided in this application, it should be understood that the disclosed apparatus and method may be implemented in other manners. For example, the described apparatus embodiments are merely examples. For example, the division into modules or units is merely logical function division and may be other division during actual implementation. For example, a plurality of units or components may be combined or integrated into another apparatus, or some features may be ignored or not performed. In addition, the displayed or discussed mutual coupling or direct coupling or communication connection may be implemented through some interfaces. The indirect coupling or communication connection between the apparatuses or units may be implemented in an electrical, mechanical, or another form.

The units described as separate parts may or may not be physically separate, and parts displayed as units may be one or more physical units, may be located in one place, or may be distributed on different places. Some or all of the units may be selected based on an actual requirement to achieve the objectives of the solutions of embodiments.

In addition, functional units in embodiments of this application may be integrated into one processing unit, or each of the units may exist alone physically, or two or more units are integrated into one unit. The integrated unit may be implemented in a form of hardware, or may be implemented in a form of a software functional unit.

When the integrated unit is implemented in the form of a software functional unit and sold or used as an independent product, the integrated unit may be stored in a readable storage medium. Based on such an understanding, the technical solutions of embodiments of this application essentially, or the part contributing to the prior art, or all or some of the technical solutions may be implemented in the form of a software product. The software product is stored in a storage medium and includes several instructions for instructing a device (which may be a single-chip microcomputer, a chip or the like) or a processor to perform all or some of the steps of the methods described in the embodiments of this application. The storage medium includes any medium that can store program code, such as a USB flash drive, a removable hard disk, a read only memory (ROM), a random access memory (RAM), a magnetic disk, or an optical disc.

In conclusion, the foregoing descriptions are merely specific implementations of this application, but are not intended to limit the protection scope of this application. Any variation or replacement within the technical scope disclosed in this application shall fall within the protection scope of this application. Therefore, the protection scope of this application shall be subject to the protection scope of the claims.

What is claimed is:

1. A data model training method, applied to a central node comprised in a machine learning system, wherein the method comprises:
receiving data subsets from a plurality of subnodes;
performing data convergence based on the received data subsets to obtain a first data set;
sending a first data model and at least one of the first data set or a subset of the first data set to a first subnode, wherein an artificial intelligence (AI) algorithm is configured for the first subnode;
receiving a second data model from the first subnode, wherein the second data model is obtained by training the first data model based on the first data set or the subset of the first data set;
updating the first data model based on the second data model to obtain a target data model; and
sending the target data model to the plurality of subnodes, wherein the plurality of subnodes comprise the first subnode.

2. The method according to claim 1, wherein the sending a first data model to a first subnode comprises:
sending, to the first subnode, at least one of parameter information and model structure information of a local first data model of the central node.

3. The method according to claim 1, wherein the receiving a second data model from the first subnode comprises:
receiving parameter information or gradient information of the second data model from the first subnode.

4. The method according to claim 1, wherein the updating the first data model based on the second data model to obtain a target data model comprises:
performing model convergence on the second data model and the first data model to obtain the target data model; or
converging the second data model with the first data model to obtain a third data model, and training the third data model based on at least one of the first data set or the subset of the first data set to obtain the target data model.

5. The method according to claim 1, wherein the sending a first data model and at least one of the first data set or a subset of the first data set to a first subnode comprises:
preferentially sending the first data model based on a capacity of a communication link for sending data; and
if a remaining capacity of the communication link is insufficient to meet a data volume of the first data set:
randomly and evenly sampling data in the first data set based on the remaining capacity of the communication link to obtain the subset of the first data set; and
sending the subset of the first data set to the first subnode.

6. The method according to claim 1, wherein if the data subset of the subnode comprises a status parameter and a benefit parameter of the subnode, the receiving data subsets from a plurality of subnodes comprises:
receiving a status parameter from a second subnode;
inputting the status parameter into a local first data model of the central node to obtain an output parameter corresponding to the status parameter;
sending the output parameter to the second subnode, wherein the second subnode performs a corresponding action based on the output parameter; and
receiving a benefit parameter from the second subnode, wherein the benefit parameter indicates a feedback obtained by performing the corresponding action based on the output parameter.

7. A data model training method, applied to a first subnode comprised in a machine learning system, wherein an artificial intelligence (AI) algorithm is configured for the first subnode, and the method comprises:
receiving a first data model and at least one of a first data set or a subset of the first data set from a central node, wherein the first data set is generated by the central node by converging data subsets from a plurality of subnodes;
training the first data model based on at least one of the first data set or the subset of the first data set to obtain a second data model;
sending the second data model to the central node; and
receiving a target data model from the central node, wherein the target data model is obtained by updating based on the second data model.

8. The method according to claim 7, wherein the receiving a first data model from a central node comprises:
receiving at least one of parameter information and model structure information of the first data model from the central node.

9. The method according to claim 7, wherein if the first subnode has a data collection capability, the training the first data model based on at least one of the the first data set or the subset of the first data set to obtain a second data model comprises:
converging the first data set or the subset of the first data set with data locally collected by the first subnode to obtain a second data set; and
training the first data model based on the second data set to obtain the second data model.

10. The method according to claim 7, wherein the sending the second data model to the central node comprises:
sending parameter information or gradient information of the second data model to the central node.

11. A data model training method, applied to a central node comprised in a machine learning system, wherein the method comprises:
sending a first data model to a first subnode, wherein an artificial intelligence (AI) algorithm is configured for the first subnode;
receiving a second data model from the first subnode, wherein the second data model is obtained by training the first data model based on local data of the first subnode;
updating the first data model based on the second data model to obtain a third data model;
receiving data subsets from a plurality of subnodes;
performing data convergence based on the received data subsets to obtain a first data set;
training the third data model based on the first data set to obtain a target data model; and
sending the target data model to the plurality of subnodes, wherein the plurality of subnodes comprise the first subnode.

12. The method according to claim 11, wherein the sending a first data model to a first subnode comprises:
sending, to the first subnode, at least one of parameter information and model structure information of a local first data model of the central node.

13. The method according to claim 11, wherein the receiving a second data model from the first subnode comprises:
receiving parameter information or gradient information of the second data model from the first subnode.

14. The method according to claim 11, wherein the updating the first data model based on the second data model to obtain a third data model comprises:
performing model convergence on the second data model and the first data model to obtain the third data model.

15. The method according to claim 11, wherein if the data subset of the subnode comprises a status parameter and a benefit parameter of the subnode, the receiving data subsets from a plurality of subnodes comprises:
receiving a status parameter from a second subnode;
inputting the status parameter into a local first data model of the central node to obtain an output parameter corresponding to the status parameter;
sending the output parameter to the second subnode, wherein the second subnode performs a corresponding action based on the output parameter; and
receiving a benefit parameter from the second subnode, wherein the benefit parameter indicates a feedback obtained by performing the corresponding action based on the output parameter.
